(19) United States
(12) Patent Application Publication
(10) Pub. No.: US 2021/0258720 A1
(43) Pub. Date: Aug. 19, 2021

(54) System and Method for Providing Location-Based Information

(71) Applicant: TomTom Navigation B.V., Amsterdam (NL)

(72) Inventor: Kees Wesselius, Amsterdam (NL)

(21) Appl. No.: 16/973,178

(22) PCT Filed: Jun. 7, 2019
(86) PCT No.: PCT/EP2019/064930

§ 371 Date: Dec. 8, 2020

(30) Foreign Application Priority Data
Jun. 8, 2018 (GB) 1809410.2

(51) Int. Cl. H04W 4/021; H04W 4/029; H04W 4/40; H04W 64/00; G01C 21/34

(52) U.S. Cl. CPC H04W 4/021; H04W 4/029; H04W 4/40; G01C 21/3453; H04W 64/006; G01C 21/3446; H04W 64/003

(57) ABSTRACT

There is provided a method for obtaining information regarding the location of a device (200) with respect to one or more predefined zone(s) (201, 202, 203) within a geographic region within which the device (200) is traveling. The method comprises obtaining a current location of the device and determining using the current location a current status of the device indicating which, if any, of the predefined zone(s) the device is currently located within. At the same time, an estimate can be made of a time interval for which the status of the device is not expected to change, and for which time interval it is therefore unnecessary to check for further updates to the status of the device. Also disclosed is a system, optionally a server, for implementing such a method.

### FIELD OF THE INVENTION

The present invention generally relates to methods for obtaining information regarding the location of a device with respect to one or more predefined zone(s) within a geographic region around which the device is traveling. Particularly, embodiments of the present invention relate to methods of geofencing. The present invention also extends to systems for performing such methods.

### BACKGROUND

There are various examples of situations where it may be desired to provide information, or otherwise trigger some action, based on the location of a device or user, e.g. relative to a certain point or area of interest. One technique for providing such location-based services is “geofencing”. Typically, geofencing techniques involve checking whether or not a suitably configured device is currently located within a predefined area of interest, and triggering some predefined action when it is determined that a device is within an area of interest, and/or outside an area of interest, depending on the application. Particularly, by creating a suitable virtual perimeter (or “geofence”) around a real-world area of interest, it is possible to determine when a location-aware device has entered (or exited) the area of interest, and then trigger a desired action associated with the area based on this. It will be appreciated that geofences are not limited to two dimensional (2D) space, and geofences may also suitably be used to define three dimensional (3D) perimeters, e.g. corresponding to a certain level or flood of a building, or a section of airspace.

A geofence is thus a virtual boundary that can be used for defining a zone of interest within a certain geographical region. The geofence can thus be used for triggering suitable alerts either to a device that is traveling within the region, or to a third party, as desired, e.g. depending on the application, based on the relative location of the device.

For example, geofences are often defined within mobile applications so that a user can download and run the application on their mobile device, e.g. a smartphone or tablet. The application may then trigger a predefined response when the mobile device enters or leaves a particular area. For instance, a venue may provide an application that will deliver relevant information about an event at the venue to users arriving at the venue. Or, a retailer might create a geofence around an outlet to trigger mobile alerts for users who have downloaded the retailer's application. In these cases the geofence may be managed and programmed into the mobile application by the administrator of the venue or retail outlet. Upon downloading the mobile application, the user can then opt in to allow location access for the application to be able to receive relevant location-based alerts. Geofences may also be set up by end-users. For instance, the user may choose an address or location where they want to receive a notification or specific action.

In these cases, the output is typically provided to a user of the mobile device, e.g. in the form of a specific alert, or push notification. However, in other cases, the location of a device relative to a geofence may trigger alerts or other information being generated for an administrator of that geofence, or another third party. For instance, another important application of geofencing is for controlling and tracking vehicles and/or containers, e.g. within the shipping industry. A geofence may thus be set up around the delivery point so that an alert may be sent to a customer when a delivery vehicle is approaching the delivery point. Or, whenever a delivery vehicle or container deviates from a planned route, or is moved from an expected (secure) location, an alert may be sent to the dispatcher or owner.

Another application of geofencing is for monitoring drones, or other light aircraft, e.g. to detect their entering a restricted airspace.

Geofencing may also be used for tracking people, and/or animals. For instance, a person or animal may be suitably tagged, e.g. with a GPS collar or ankle strap, in order to monitor their location and generate an alert when it is determined that they have entered a restricted area, or similarly have left a permitted area. As one further example, geofencing may be used with “smart” or Internet of Things (“IoT”)-enabled devices, e.g. to only permit operation of the device within a certain operating area such as a user's home. It will be appreciated, however, that various other arrangements and applications of geofencing are of course possible and the techniques described herein may generally be applied to any suitable and desired application.

To make use of geofencing, the geospatial location of the virtual perimeter (geofence) must first be defined, e.g. within an electronic map, along with details of the actions that are to be associated with the geofence. Typically, the geofences, and actions, may be contained within a suitable application program interface (“API”). In order to check whether a device is currently located within any geofence(s) of interest, i.e. to determine a current status of the device with regard to any or all geofences of interest, the device may therefore need to periodically access, e.g. or report its location to, the API. Thus, when using conventional geofencing techniques, maintaining a more accurate (i.e. continual) knowledge of the status of the device as it moves around a certain geographic region requires checking relatively often for updates to the status, i.e. with a relatively high checking frequency. However, each instance of the device checking with the API for an updated status report requires processing by the device, and regularly checking the current status may therefore be potentially highly battery draining. Also, at least where the device has to communicate with an online API, regularly checking for status update may involve higher bandwidth (i.e. over the air data) usage and may place a relatively high load on the service.

Thus, the Applicants believe that there remains scope for improvement in these regards.

### SUMMARY

From a first aspect, the present invention provides a method for obtaining information regarding the location of a device with respect to one or more predefined zone(s) within a geographic region around which the device is traveling, the method comprising:

obtaining a current location of the device within the geographic region;

determining using the current location of the device a status of the device with respect to the one or more predefined zone(s) within the geographic region, wherein the status indicates which, if any, of the predefined zone(s) the device is currently located within;

providing the determined status for output; and

estimating using the current location of the device and the relative location(s) of the one or more predefined zone(s) a time interval for which the status of the device is not expected to change.

According to embodiments, the present invention involves determining a current status of a device with respect to one or more predefined zone(s) within a geographic region. The predefined zones may be defined using virtual geofences. In other words, the techniques presented herein may generally relate to methods of geofencing. For example, the device may report its current location to a suitable application program interface (“API”) for checking its current status. Based on the current location of the device a determination can be made as to which (if any) of the predefined zone(s) the device is currently located within. The determined status may then be provided for output, e.g. to (a user of) the device, or to some other third party, as desired, e.g. depending on the application. It will be appreciated that in order to maintain an accurate status for a device as the device moves around the geographic region it may be necessary to substantially continually obtain an updated location of the device. However, this step can place a significant burden on the processing and/or bandwidth resource of the device, especially where the device is reporting its location via an online interface to a remote server.

Thus, in embodiments, an estimate is made of a time interval for which the status of the device is not expected to change, and for which time interval there is therefore no need to check for updates. This estimate may be computed using the current location of the device as well as the relative positions of the boundaries of the predefined zone(s) of interest, e.g. by calculating an estimate of the time taken for the device to reach the nearest zone boundary based on certain assumptions regarding the direction and speed of travel. In this way, the frequency with which the status needs to be checked can be substantially optimised, or reduced, without risking losing accuracy of the service. For instance, because it is not expected that any request to the service within the estimated time interval will result in any change in the status of the device, the device may effectively ‘sleep’ to save power and over-the-air costs during this time interval since there is no need to obtain an updated location and generate a new status report until the time interval has elapsed. Thus, when a (first) status has been determined, an estimate can then be made of how long to wait before checking for an update to the status. The interval between updates may thus be adjusted, and substantially optimised, based on the current location of the device. Accordingly, the bandwidth and/or battery usage of the device when using the service can be reduced, as can the overall load on the service, potentially allowing for faster response times.

By contrast, when using conventional geofencing techniques, the number of instances of having to obtain and process the current location to determine a status, and hence the processing load, can only be reduced by arbitrarily reducing the update frequency, potentially losing accuracy of the service. That is, where the update frequency is reduced blindly there is a risk that a status change may be missed. There is often therefore a trade-off between bandwidth/battery usage and accuracy of the service.

From a second aspect of the present invention there is provided a system for obtaining information regarding the location of a device with respect to one or more predefined zone(s) within a geographic region around which the device is traveling, the system comprising processing circuitry configured to:

obtain a current location of the device within the geographic region;

determine using the current location of the device a status of the device with respect to the one or more predefined zone(s) within the geographic region, wherein the status indicates which, if any, of the predefined zone(s) the device is currently located within;

provide the determined status for output; and

estimate using the current location of the device and the relative location(s) of the one or more predefined zone(s) a time interval for which the status of the device is not expected to change.

This second aspect can and in embodiments does include any one or more or all of the preferred and optional features described herein in respect of the first aspect of the invention, in any of its embodiments, as appropriate. For example, even if not explicitly stated, the system may comprise means for carrying out any step or steps described in relation to the method herein in any of its aspects or embodiments, and vice versa.

The present invention is preferably a computer-implemented invention. Any of the steps described in relation to any of the aspects or embodiments of the invention may therefore suitably be carried out under the control of a set of one or more processors and/or suitable processing circuitry. The processing circuitry may generally be implemented either in hardware or software, as desired. For instance, and without limitation, the means or processing circuitry for carrying out any of the steps described in relation to the method or system may comprise one or more suitable processor or processors, controller or controllers, functional units, circuitry, processing logic, microprocessor arrangements, etc., that are operable to perform the various steps or functions, etc., such as appropriately dedicated hardware elements (processing circuitry) and/or programmable hardware elements (processing circuitry) that can be programmed to operate in the desired manner.

The system and/or one or more processors and/or processing circuitry may be at least part of a server. The steps of the method of the present invention in any of its aspects or embodiments may therefore be carried out in part by a server. It will be appreciated that in various embodiments the steps of the method may be performed exclusively on a server, or some on a server and the others on a device in any combination, or exclusively on a device. If one or more steps are performed on the device, this may reduce any bandwidth required for network communication. However, in preferred embodiments, at least some, and in some cases all, of the steps are performed on a server. Performance of one or more of the steps on the server may be efficient and may reduce the computational burden placed on the device. Accordingly the invention can encompass a server operable to obtain information regarding the location of a device with respect to one or more predefined zone(s) within a geographic region around which the device is traveling. The device may therefore be a device that is capable of communicating with the server, e.g. via a suitable online interface. The device may thus comprise suitable wireless communication circuitry for communicating with the server. In this case, although other arrangements are of course possible, the device may determine its location, and the server may then obtain the current location of the device from the device, and process the obtained current location accordingly, e.g. as described herein.

The device may be any device that is capable of determining its own geospatial location (e.g. in terms of latitude, longitude and optionally altitude). For example, the device may suitably comprise means for accessing and receiving information from Wi-Fi access points or cellular communication networks, such as a GSM device, and using this information to determine its location. In embodiments, the device comprises a global navigation satellite systems (GNSS) receiver, such as a GPS receiver, for receiving satellite signals indicating the position of the receiver at a particular point in time, and which preferably receives updated position information at regular intervals. For example, in embodiments, the device may comprise a mobile telecommunications device such as a smartphone, or a smartwatch or tablet having suitable positioning capability, position sensors, and the like. In other embodiments, the device may be a suitably configured wearable or implantable device. For example, the device may comprise an electronic tag or collar. As yet another example, the device may comprise a navigation device, such as a portable navigation device of the type generally known in the art, or be part of an in-vehicle navigation system. However, a person skilled in the art will appreciate that various other arrangements would of course also be possible, e.g. depending on the application.

The device may generally be associated with a user. For example, in embodiments, the user may wear, or otherwise carry the device with them, as they travel (e.g. walk) within the geographic region. In this case, the position of the device will correspond to the position of the user, and suitable actions may be triggered for, or information provided to, the user based on their location. Additionally, or alternatively, the device may be associated with a vehicle and/or an object. In these embodiments the position of the device will correspond to the position of the vehicle/object. References to the location of the device may thus be replaced by a reference to a location of the vehicle/object, and vice versa, even if not explicitly mentioned. The device may be integrated with the vehicle/object, e.g. as part of an in-vehicle navigation system or display, or may be a separate device that is associated with (e.g. mounted on) the vehicle/object.

The device is traveling (i.e. or at least able to travel) within a geographic region. In some cases, e.g. where the device is associated with a vehicle, the device may be constrained to travel within the geographic region along a navigable network. For example, road vehicles such as cars or trucks are generally constrained to travel along a road network. It will be appreciated that the navigable network is not limited to a road network, and depending on the application, may comprise, for example, a network of foot paths, cycle paths, rivers, tow paths, railway lines, or the like. In other cases, the device may be able to travel essentially freely around the geographic region. For example, this may be the case where the device is associated with a drone, or is being carried or worn by a user.

In embodiments, the geographic region may be represented by a suitable electronic map, as is generally known in the art. That is, the geospatial co-ordinates (e.g. latitude, longitude and optionally altitude) of points within the geographic region may be represented or stored as an electronic map, or more precisely as electronic map data. Where the geographic region contains a navigable network, i.e. to which the device is constrained to travel, the navigable network may also be defined within the electronic map.

The geographic region within which the device is traveling contains one or more predefined zone(s) of interest. These are zones that have previously been defined within, or relative to, the geographic region, and that may be suitably delimited by virtual perimeters, e.g. or “geofences”. The geospatial locations of the predefined zones (e.g. in terms latitude, longitude and optionally altitude) may thus be defined virtually, e.g. within some application. That is, the predefined zones are “virtual” zones. Accordingly, whilst a predefined zone may correspond to a real-world zone of interest, e.g. an industrial zone, or an airport, it will be appreciated that in general the predefined zones may have any desired shape and size. For instance, often, a predefined zone of interest may be defined relative to a certain point of interest. For example, the predefined zone may thus comprise a polygon, such as a rectangle or circle, drawn around the point of interest with a desired extent or radius. That is, a predefined zone may in some cases comprise a two-dimensional (2D) zone, or area. In other cases, the zone of interest may be defined in three-dimensional (3D) space, and may thus comprise a suitable volume or polyhedron extending about a point of interest. It will be appreciated that the predefined zones may thus also be associated with an electronic map representing the geographic region, where one is provided. For example, the predefined zones may comprise virtual zones defined within, or at least relative to, the electronic map representation of the geographic region. That is, in embodiments, the geographic region is represented by an electronic map and the one or more predefined zone(s) are defined within the electronic map. The predefined zones are typically associated with an administrator, i.e. the person who has created the geofence.

In some cases the presence and/or location of a predefined zone may also be time-dependent. That is, in addition to their geospatial location, and extent, a predefined zone may also have an associated temporal profile. In this way, actions may only be triggered at certain times of the day, or only when a certain event is taking place, or different actions may be triggered depending on the time. So, which predefined zones are present within the geographic region may depend on the current time.

Within a given geographic region there may be a plurality of predefined zones. These may potentially overlap with each other. The predefined zones are generally independent of one another and a status may thus be determined separately for each predefined zone. In some cases, the user may be interested only in a certain subset of the predefined zones and the user may therefore opt in which predefined zones are of interest. Thus, it will be appreciated that any references herein to determining a status of a device relative to one or more predefined zones may include determining a status relative to (only) selected ones of predefined zones of interest, i.e. that the user has opted in to access. Alternatively, this may be set based on an application installed by the user or an administrator of the predefined zone.

According to the present invention, a current location of a device is obtained for use in determining the current status of the device relative to the predefined zone(s) of interest. The device is generally able to determine its own location, e.g. using suitable GNSS or other location-determining data. Typically, the current location of the device is therefore determined by the device itself. The method may thus involve a step of the device determining its current location. The current location may then be reported and processed as described herein. In some embodiments, the step of obtaining the current location of the device may comprise accessing the data, i.e. the data being previously received and (at least temporarily) stored. For instance, when the steps of the method are performed on a server, the server may obtain the current location of the device from the device, and the server may then access the current location and process it accordingly. That is, the device may report its location to the server, or the server may request a location from a device, in order for a current status of the device to be determined. Thus, in some embodiments, the method may comprise receiving (e.g. at a server, or other processing means) from the device data indicative of the current location of the device. In this case, the method may further comprise storing the received positional data before proceeding to carry out the other steps of the present invention. It will be appreciated that the step of receiving the positional data need not take place at the same time or place as the other step or steps of the method.

From the current location, regardless of how this is obtained, the method proceeds to determine a current status of the device with respect to one or more predefined zone(s) within the geographic region within which the device is traveling. The status of the device with respect to the one or more predefined zone(s) may generally be determined by comparing the current location of the device with the positions of the predefined zone(s). For example, when the predefined zone(s) are defined relative to or within an electronic map, the method may comprise matching the obtained location of the device to the electronic map in order to determine the current status of the device. This comparison may typically be performed based on the current latitude, longitude and optionally altitude of the device. For instance, where the current location of the device falls within a perimeter of a particular predefined zone, the status will indicate that the device is currently located within that zone. On the other hand, when the current location of the device is outside a perimeter of a predefined zone, the status may indicate that the device is currently located outside that zone. A status report may thus be generated comprising a list of the predefined zone(s) which the device is currently located within and/or a list of the predefined zone(s) (of interest) within which the device is currently located outside.

The current status of the device may then be provided for output, e.g. either to the device, or to a third party, as desired, e.g. depending on the application. The method may comprise providing a location-based service using the determined status. For example, the current status of the device may be provided to the device for generating information, e.g. for display to a user of the device, or for triggering some other action based on the determined status. That is, in embodiments, the method may comprise providing the determined status for output to the device and/or generating information based on the determined status for output to the device. Alternatively, or additionally, the method may comprise providing the determined status for output to a third party and/or generating information based on the determined status for output to a third party. That is, in other embodiments, the current status of the device may be output to processing circuitry on a server, and used to generate information that is then provided to the device. That is, the status of the device need not be reported back to the device, and instead information based on the status may be provided to the device. Still in other embodiments, rather than providing information or triggering an action on the device based on the current status, information may be provided to a third party. For example, the current status of the device may be provided to, or used to provide information to, an administrator of one or more of the predefined zone(s). Or, information may be provided to another desired party based on the current status. In general, any suitable location-based service may be provided based on the current status of the device in a known manner.

According to embodiments of the present invention, when a status of the device is determined, an estimate is also made of a time interval for which the status of the device is not expected to (or preferably could not possibly) change. For example, whenever a status is determined, at the same time (e.g. or after) the status is determined, an estimate is made of a time interval for which the status of the device is not expected to change status. The system can then wait for this time interval to pass before determining a new status.

This time interval can be estimated using the current location of the device and the relative position(s) of the one or more predefined zone(s). For example, it will be appreciated that the status of the device will change (and can only change) when the device crosses a perimeter of a predefined zone of interest, e.g. where the device enters a new predefined zone, or alternatively when the device exits a predefined zone which it is currently located within.

Accordingly, in embodiments, the time interval may be estimated by calculating a travel time from the current location of the device to a perimeter of the one or more predefined zone(s). For example, the time interval may be estimated by calculating the shortest travel time, e.g. assuming that the device travels directly, i.e. along the shortest possible (and/or permitted) route, from its current location to a perimeter of the one or more predefined zone(s). Typically the time interval will be estimated by calculating the travel time to the nearest zone perimeter, as this will normally have the shortest associated travel time. However, in some cases, travel times may be calculated to the perimeters for multiple, or all (at least within a certain range of the current location), predefined zones within the geographic region, and the shortest calculated travel time may then be used for estimating the time interval.

Thus, embodiments of the invention may make an approximation of a ‘worst-case’, or most pessimistic, i.e. shortest, time interval for which the status of the device is not expected to change. Accordingly, although it is possible that the status will change within this time interval, in practice the chances that the status of the device will have changed may still be relatively low since it is unlikely that the device will actually have traveled directly to the zone perimeter along the shortest possible path. That is, in reality, the time taken for the device to reach the next zone perimeter may be longer than the calculated travel time and estimated time interval. On the other hand, it is very unlikely, or impossible, that the status will have changed before the estimated time interval has elapsed. Thus, there is no need to check for an update until this time, and the interval between checking for updates to the current status can be substantially optimised, in order to reduce the load on the device and/or service, as described above.

The travel time may in some cases be calculated by assuming that the device travels in a straight line to the nearest zone perimeter. This may be appropriate where the device is able to move freely around the geographic region, and is not e.g. constrained to travel along a navigable network. However, in cases where the device is constrained to travel along a navigable network, the travel time may be calculated by assuming that the device travels directly to a perimeter along the shortest path within the navigable network. For instance, the shortest path to a perimeter may be determined using any suitable and desired route planning algorithms, e.g. as are generally known in the art. In this case, the route planning algorithm may also take into account (e.g.) speed restrictions and/or traffic conditions within the navigable network. It will be appreciated that using the navigable network to calculate the travel time, where appropriate, may thus give a more accurate or realistic travel time. Also, taking account of the navigable network will always give a longer travel time than assuming the device travels in a straight line to the nearest perimeter, since the navigable network can only act to slow down the device. Thus, in this case, the time interval between updates may be increased further without risking losing accuracy.

To calculate the travel time certain assumptions may be made regarding the travel speed and direction of the device. For instance, in some cases, the time interval may be estimated by calculating the travel time for the device to reach a perimeter assuming that the device travels directly to the perimeter at a constant travel speed. Particularly, the calculation may assume that the device travels directly to the perimeter at a maximum travel speed. The maximum travel speed may be a maximum possible speed of the device. For example, for cars, it might reasonably be assumed that the maximum travel speed is about 200 km/h. Alternatively, the maximum travel speed may be a maximum permitted (e.g. legal) travel speed within the geographic region. This may effectively give a lower bound for the time interval for which the status of the device is not expected to change. This may be necessary, or desirable, at least in some cases. For example, it may be desirable to use this lower bound in cases where there is no other information available regarding the actual travel speed or direction of the device, e.g. when estimating the first time interval after the service is opened and an initial status is determined, or where it is desired to ensure that the current status is highly accurate, e.g. for law enforcement applications where it is important to reliably know the current device location.

However, a more accurate, or realistic, estimate of the travel time may be calculated using (knowledge of) the actual travel speed or direction of the device, where this information is available, or can be determined. That is, in embodiments, the travel time may be calculated using information indicative of the current travel direction and/or travel speed of the device. In some cases, the device may know, or be able to determine, its current travel direction and/or travel speed, and this information may thus be obtained along with the current location of the device for use in calculating the travel time. This may also be determined or estimated from the navigable network, where one is provided, e.g. where the average speeds for traveling along the elements of the navigable network are known. In other cases, the current travel direction and/or travel speed of the device may be determined (estimated) from the current location of the device along with any previously obtained location(s). That is, an approximate travel direction and/or travel speed may be determined based on the change in location of the device over time. In this case, as more information is obtained regarding the movement of the device throughout the geographic region, the estimate of the time interval for which the device status is not expected to change may be refined.

The time interval may be set as being the calculated (shortest) travel time. However, it is also contemplated that the time interval may be adjusted further or take into consideration other factors, e.g. depending on the application. For example, the time interval may be set as being slightly shorter or longer (e.g. by a fixed percentage or amount) than the calculated travel time depending on the desired level of accuracy for the service. For instance, for applications where it is necessary to know the current status with a high reliability, a ‘strict’ policy might be applied where the time interval is set as being exactly the calculated travel time, or even slightly shorter than this, so that the status is checked more regularly. For instance, the ‘strict’ policy may always use the most pessimistic assumptions regarding the travel time, e.g. by assuming that the device travels directly to the closest perimeter at a maximum speed. On the other hand, where it is desired to reduce processing, a ‘sloppy’ policy might be applied wherein the status is checked less regularly. It will be appreciated that various other policy preferences may be applied as desired.

In embodiments, the estimated time interval may then be provided for output to the device (optionally along with the current status of the device and/or information based on the current status of the device, as mentioned above). In these embodiments, the device is thus told that it does not need to check for any status updates until the estimated time interval has elapsed. The device therefore does not need to make any requests during this time interval and may therefore save battery, and so on. However, other arrangements are of course possible. For example, where the device is communicating with a server for determining a status of the device, instead of the server returning the estimated time interval to the device, the server may return information indicative of a distance to a perimeter from which the device can then estimate a time interval to wait before checking for updates. In some cases, the device need not know the estimated time interval at all. For example, a request for a location from a device might be initiated by the server, in which case the server may be configured to not make another request until the estimated time interval has elapsed. In this example, the device need not do anything until a request is received from the server, and may stay in a relatively low power watchdog mode until a request is received.

The steps of the method may then be repeated to determine an updated status of the device. For instance, after waiting for the estimated time interval to elapse, an updated status may be determined by obtaining an updated current location of the device, and so on. Thus, in embodiments, when (e.g. only when) the estimated time interval has elapsed, the method comprises obtaining an updated current location of the device and determining using the updated current location an updated status of the device. Accordingly, in embodiments, the method comprises obtaining a first location of the device within a geographic region at a first time; determining using the first location of the device a first status of the device with respect to the one or more predefined zone(s) within the geographic region, wherein the status indicates which, if any, of the predefined zone(s) the device is located within at the first time; providing the determined first status for output; and estimating using the first location of the device and the relative location of the one or more predefined zone(s) a first time interval for which the status of the device is not expected to change. When the first time interval has elapsed, a second location of the device is obtained at a second time, from which a second, updated status is determined and provided for output. A second time interval can then be estimated from the second location of the device and the relative location(s) of the one or more predefined zone(s) (optionally as well as the first location), wherein the second time interval is indicative of a time interval from the second time for which the status of the device is not expected to change. The method can then wait until the second time interval has elapsed before obtaining a third or further location of the device and determining a third or further status.

It will be appreciated that the methods in accordance with the present invention may be implemented at least partially using software. It will thus be seen that, when viewed from further aspects and in further embodiments, the present invention extends to a computer program product comprising computer readable instructions adapted to carry out any or all of the method described herein when executed on suitable data processing means. The invention also extends to a computer software carrier comprising such software. Such a software carrier could be a physical (or non-transitory) storage medium or could be a signal such as an electronic signal over wires, an optical signal or a radio signal such as to a satellite or the like.

The present invention in accordance with any of its further aspects or embodiments may include any of the features described in reference to other aspects or embodiments of the invention to the extent it is not mutually inconsistent therewith.

It should be noted that references to a location, or status, etc., of the device, herein should be understood to refer to data indicative of these unless the context demands otherwise. The data may be in any way indicative of the relevant parameter, and may be directly or indirectly indicative thereof. Thus any reference to a location, or status, etc., may be replaced by a reference to data indicative thereof, i.e. location data, or status data. It should also be noted that the phrase “associated therewith” should not be interpreted to require any particular restriction on data storage locations. The phrase only requires that the features are identifiably related.

Various features of embodiments of the invention will be described in further detail below.

### FIGURES

Various aspects of the teachings of the present invention, and arrangements embodying those teachings, will hereafter be described by way of illustrative example with reference to the accompanying drawings, in which:

FIG. 1 is a flowchart illustrating an example of a method according to embodiments of the present invention;

FIG. 2 shows schematically an example of a geofencing method according to embodiments of the present invention; and

FIG. 3 shows schematically an example of time predictor logic for use according to embodiments of the present invention.

### DESCRIPTION

Embodiments of the present invention relate to methods of geofencing. As will be understood, and as used herein, “geofencing” generally refers to the activity of checking in which predefined zone(s) of interest a device is currently located within. Thus, the typical task in geofencing is to determine in which predefined zones a certain device is located within. Based on this, a geofencing report can be generated essentially being a list of the predefined zones the device is currently located within. In general, the predefined zones may represent any areas or zones of interest where it might be desired to provide some location-based service. For instance, it will be understood that the predefined zones are “virtual” zones, e.g. which may be created and/or defined within an electronic map using a map tool. The predefined zones of interest may therefore comprise any suitably geospatially defined shapes, whether two dimensional polygons, such as rectangles or circles, or three dimensional shapes, extending around a real-world zone or point of interest. The geofencing device can thus report its position to suitable geofencing logic (which may e.g. be located on a server) which computes which zone(s) the device is in. This information may then be reported back to the object to enable the device to perform its business logic, whatever that is. In other cases, it may be that a third party is interested in the location of the device. In these cases, the geofencing report may instead be provided to the third party, rather than being provided back to the device.

It should be understood that the present invention may find utility for any suitable applications where geofencing might desirably be used, e.g. to provide some location-based service. However, by way of example, various embodiments of the invention will now be described further with particular reference to a location-aware mobile device, such as a smartphone, running a mobile application that uses an online navigation application programme interface (“API”) for communicating with a server for providing location-based services. That is, in these embodiments, the invention is primarily implemented on the server side. However, it will be appreciated that the invention is of course not limited to such arrangements. For instance, in embodiments, at least some of the processing may be performed by the device rather than at the server. Furthermore, it will be appreciated that the techniques need not be implemented using a mobile device such as a smartphone, and any suitably location-aware device may be used. For example, depending on the application, the device may, among other examples, comprise a tablet, a smartwatch, a navigation device, an electronic collar or tag, or the like.

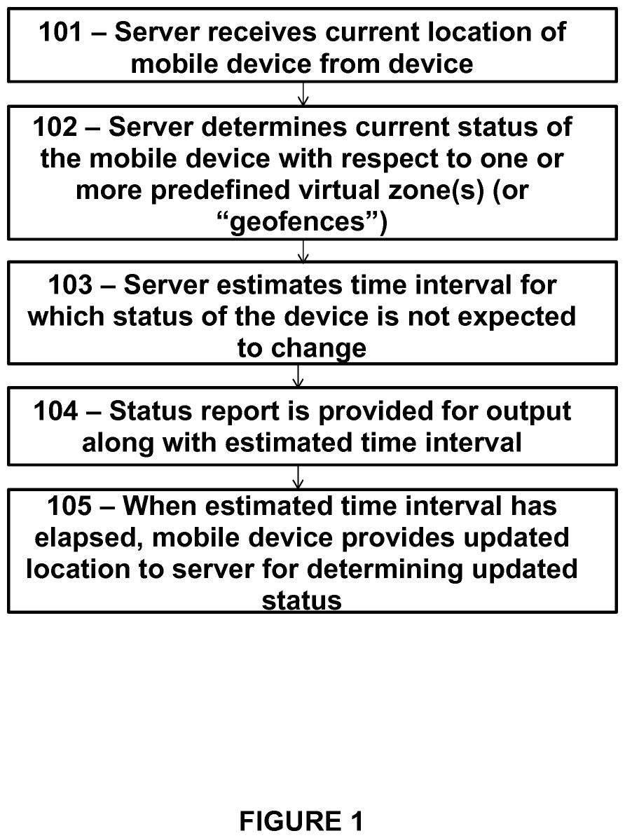

FIG. 1 is a flowchart illustrating an example of a method according to embodiments of the present invention. As shown, the method starts by obtaining a current location of the mobile device (step 101). Particularly, in the embodiment shown in FIG. 1, the mobile device is able to determine its own geospatial location, e.g. via GPS, and report this via a suitable online API to a server. The device may therefore send its current location to the server along with a request for its current status. Thus, once the server has received the current location of the mobile device, the server then actions this request and determines from the current location a current status of the mobile device with respect to one or more zones of interest that have been previously defined within the geographic region and whose positions are stored, or at least can be accessed by, the server (step 102). The predefined zones may be any suitably defined zones of interest. For example, an zone of interest might be an industrial zone, airport zone or any other zone where special legislation or considerations might apply, or indeed any other zone wherein it might be desired to provide some service, or information, e.g. to broadcast relevant alerts or messages, based on the location of the device. These zones of interest can thus be defined virtually by creating suitable geofences within the online API. Based on the current location of a device, a geofencing report comprising a list of which predefined zones the device is currently located within (or not within) can thus be generated and provided for output to the device.

When using conventional geofencing methods, these steps would have to be regularly and periodically repeated according to a certain online check frequency to continually generate accurate (i.e. up to date) geofencing reports. However, the Applicants have recognised that this may involve a significant burden on the processing and bandwidth resource of the mobile device. Thus, according to embodiments, before the mobile device sends an updated location to the online mobile application device for receiving an updated geofencing report, an estimate is made of a time interval for which the status of the device is not expected to change (step 103). The system thus knows that it can wait at least until this time interval has elapsed before checking for any status updates without any significant loss in accuracy since it is expected that the status will not have changed. The estimated time interval can then be provided along with the geofencing report for output to the device (step 104). The device is thus told that there is no need to request an updated status until the estimated time interval has elapsed. When the estimated time interval has elapsed is, the mobile device then provides its updated location to the server and requests an updated status (step 105). In this way, the time interval between updates can be substantially optimised (e.g.

reduced) without losing accuracy, thus helping reduce the power and bandwidth usage of the mobile device. In turn, this may result in a lower load on the service, and faster responses, since fewer requests are sent to the server.

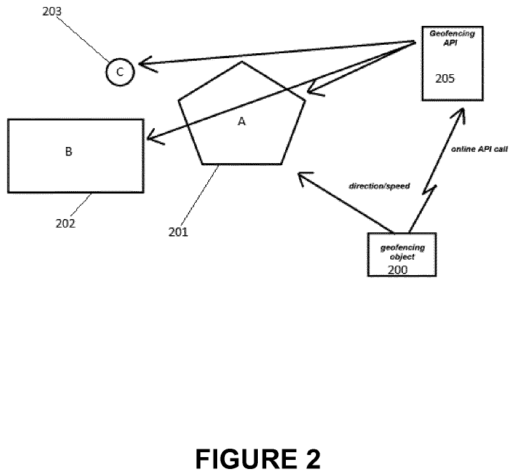

In general, the estimate of the time interval for which the status of the device is not expected to change (i.e. step 103) can be made by calculating the shortest travel time for the device to reach the next perimeter of a predefined zone of interest. This is illustrated in FIG. 2. In the example shown in FIG. 2, the mobile device 200 is traveling within an zone in which three geofences 201, 202, 203 have been defined. As described above, in this example, the mobile device 200 communicates with an online API 205 that contains the geofencing logic. The mobile device 200 is thus able to make an online call to the API 205 for generating a geofencing status report.

At the instant depicted in FIG. 2, the mobile device 200 is not currently located within any of the geofences 201, 202, 203. The status of the mobile device 200 will not therefore change until the mobile device 200 enters one of the geofences 201, 202, 203. Thus, by estimating the travel time for the mobile device 200 to reach the nearest geofence 201, it is possible to estimate a time interval for which the status of the device is not expected to change.

For example, after the initial (first) online check has been made, the online API 205 now knows where the mobile device 200 is located within the geographic region, and also knows the relative distances to the geofences 201, 202, 203. The online API 205 can thus calculate a travel time from the current location to the nearest geofence 201 by making certain assumptions regarding the travel speed and direction of the mobile device 200.

For instance, initially, the online API 205 may know the current location of the device, but have no knowledge of the current travel speed or direction. In this case, the online API 205 may estimate a time interval for which the status will not change by assuming that the device 200 moves straight to the nearest geofence 201 at its maximum possible speed. So, if the nearest geofence is located a distance, D, away from the current location of the mobile device 200, and the mobile device 200 is capable of moving at a maximum possible speed, S, it will take a time of at least T=D/S for the mobile device 200 to reach that geofence 201 (e.g., for cars, a maximum possible speed, S, of about 200 km/h could be reasonably assumed). Thus, there is no need to check for any updates at least until the time interval T has elapsed. This information may thus be passed to the device along with the geofencing report to tell the mobile device 200 not to check again until the time interval T has elapsed.

When the time interval T has elapsed, the mobile device 200 reports its new location to the online API 205 and request an updated status report. At this point, the logic behind the API 205 now has knowledge of the updated current location and also of the previous location(s) of the mobile device 200. The logic is thus able to compute an approximate speed and direction of travel of the mobile device 200 and this information can be used in the calculation of the next estimate for the time interval T for which the status is not expected to change. For instance, by using knowledge the actual speed and direction of travel to refine the calculated travel time to the nearest perimeter the estimate of the time interval may be more realistic, and less pessimistic than the above case where it was assumed that the device travels straight to the nearest perimeter as fast as possible, as the calculated travel time is now based on more empirical observations. The online API reports the new time interval T and the device 200 can wait that time before checking the online API again.

When the device 200 is within a geofence, essentially the same logic applies. For example, in that case, the time interval T may still be determined based on the travel time to the nearest perimeter of a geofence which may either be a geofence within which the device is currently located (in which case the status change is that the device has left that zone) or a perimeter of another geofence, if that is closer.

Thus, in the embodiments described above, the device is provided along with the geofencing report with an estimation of the time that the device can travel around before checking online for an updated status. However, other arrangements would of course be possible. For instance, the device may alternatively (or additionally) be provided, e.g. as part of the geofencing report, with a distance to the nearest geofence(s), so that the device itself may determine the time interval it should wait before checking for an updated status.

Various classes of transportation can be distinguished when calculating the expected travel time, with each class of transportation having different parameters for estimating the travel time. For example, where the device is able to travel substantially freely, e.g. where the device is associated with an aircraft, or is carried by a pedestrian within a pedestrianized region, there cannot generally be any assumptions on the future direction of travel. In these cases, the travel time may therefore be calculated by assuming that the device moves at the maximum possible speed in a straight line to the nearest geofence. The travel time in this case is thus simply the distance to the nearest geofence divided by the maximum possible speed. The maximum possible speed may be configured once for the device, or may be assumed based on the vehicle class associated with the class (e.g. for cars a maximum possible speed of about 200 km/h may be reasonable). Or, the device can report its expected or actual travel speed, and the time interval can be adjusted accordingly.

In other cases, the device cannot move freely. For example, this may be the case where the device is associated with a boat traveling along a canal network, or a road vehicle driving on a road network. In this case, the device has to follow the navigable network. This effectively reduces the net speed at which the device approaches the nearest geofence. For example, considering a road vehicle, the vehicle can only reach the nearest geofence by traveling along the road network, which offers only a few routes for doing this. In these cases, in embodiments, the method may thus use a shortest time route planning to determine the shortest travel time along the road network to a geofence. Various examples of route planning algorithms are known that may suitably be used for this purpose. For example, the route planning algorithm may plan various routes from the current location to any or all points on the nearest geofence. The route having the shortest travel time can then be selected for use in estimating the time interval for which the device can stay offline before checking for an updated status. The route planning algorithm may take into account the topology of the navigable network, including e.g. the presence of one-way streets, and vehicle restrictions (such as size restrictions), as well as expected or current traffic conditions and speed restrictions within the network. The route planning algorithm may also therefore include details of the vehicle type. In this way, the route planning algorithm can make the possible assumptions about the travel path, giving a more reliable estimate of the time for which the status is not expected to change. Naturally the time interval estimated in this way is larger than in the previous case, as the road topology and traffic conditions can only act to slow the device down.

The component that will finalise the estimate of the time interval for which the status of the device is not expected to change may thus use a combination of the device type (e.g. whether the device is associated with a vehicle), its maximum possible speed, its expected course (e.g. for airplanes it is known that they typically fly in the same direction for hours), whether the device is constrained to travel along a navigable (e.g. road) network, and so on. This combination of parameters and observations makes a useful expected interval for the object to be safely offline without changing state in any of the geofences.

Other assumptions could be used for tweaking the estimated time interval or the calculation of the travel time needed to reach the nearest fence. For example, in some cases, various different policy levels may be applied, e.g. ‘strict’, ‘average’ or ‘sloppy’, for determining how safe the assumptions should be. For instance, for legal applications, a stricter policy may be used which assumes the maximum possible speed and that the device travels directly towards the nearest fence at this maximum speed. For other applications, it may depend on the desired battery usage. For example, a sloppier policy may use less battery/bandwidth.

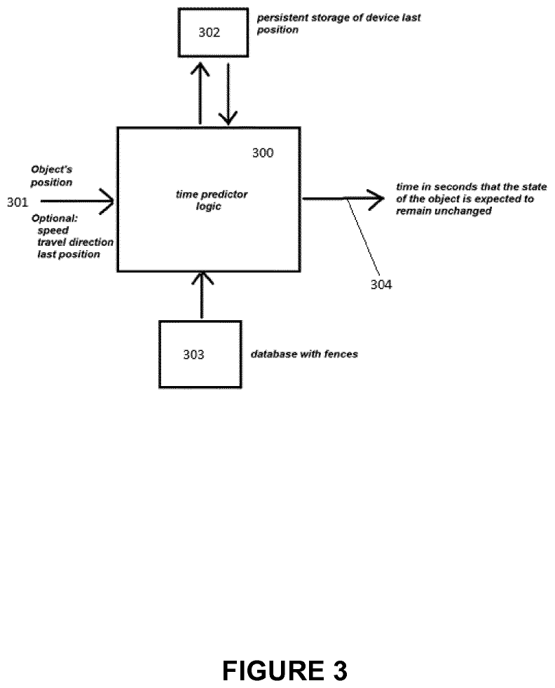

FIG. 3 shows an example of the time predictor logic 300 that may be provided within the online API alongside the regular geofencing logic. It will be appreciated that providing the time predictor logic 300 on the online API helps reduce the processing requirements on the mobile device 200. As shown in FIG. 3, the time predictor logic 300 may receive at a first input 301 the current location of the device, optionally along with any other information e.g. indicative of the speed, travel direction and last position of the device. The last position of the device may also be stored in a persistent memory 302. The time predictor logic 300 also has access to a database within which the relative locations of the geofences are stored. Based on these inputs, the time predictor logic may then provide as output 304 an estimate of a time interval (e.g. in seconds) for which the status of the device is expected to remain unchanged.

Thus, embodiments of the invention make an approximation of the travel time for the device to reach the nearest geofence. This travel time can then in turn be used to determine a time interval for which it is not expected that the status of the device will change (or for which the status of the device cannot change), i.e. as the device is currently too far away from the nearest geofence, and traveling too slowly, to reach the geofence within this interval. For instance, this time interval can be computed and communicated back to the object each time its status is checked. Accordingly, the geofencing device can be configured to only call the online API when there is a reasonably high possibility that its status has changed. For example, the device may be told to not contact the API again until the time interval has elapsed, as it is extremely unlikely, or even impossible, for anything to have changed during this time. This may help reduce the battery and bandwidth usage of the device, since the device may need to make fewer calls to the service. Similarly, since useless calls may be eliminated, fewer calls may be made to the server as a whole, resulting in lower cost for the service and a faster response time for calls that are made.

In various embodiments described above, the processing is primarily implemented on the server side of an online geofencing service. These embodiments may therefore be particularly suited for use with low power, low bandwidth mobile devices. However, it is also contemplated in some cases that the invention may be implemented at least in part on the device. Thus, it will be appreciated that whilst various aspects and embodiments of the present invention have heretofore been described, the scope of the present invention is not limited to the particular arrangements set out herein and instead extends to encompass all arrangements, and modifications and alterations thereto, which fall within the scope of the appended claims.

It should also be noted that whilst the accompanying claims set out particular combinations of features described herein, the scope of the present invention is not limited to the particular combinations hereafter claimed, but instead extends to encompass any combination of features or embodiments herein disclosed irrespective of whether or not that particular combination has been specially enumerated in the accompanying claims at this time.

1. A method for obtaining information regarding the location of a device with respect to one or more predefined zones within a geographic region within which the device is traveling, the method comprising:
obtaining a current location of the device within the geographic region;
determining using the current location of the device a status of the device with respect to the one or more predefined zones within the geographic region, wherein the status indicates which, if any, of the predefined zones the device is currently located within;
providing the determined status for output; and
estimating using the current location of the device and the relative locations of the one or more predefined zones a time interval for which the status of the device is not expected to change.

2. The method of claim 1, wherein estimating the time interval for which the status of the device is not expected to change comprises calculating a travel time from the current location of the device to a perimeter of the one or more predefined zones.

3. The method of claim 2, wherein estimating the time interval for which the status of the device is not expected to change is comprises calculating the shortest travel time from the current location of the device to a perimeter of the one or more predefined zones assuming that the device travels directly to the perimeter along the shortest possible and/or permitted path.

4. The method of claim 2, wherein the device is associated with a vehicle, and wherein the vehicle is constrained to travel along a navigable network within the geographic region, wherein the travel time is calculated using the shortest path to a perimeter of the one or more predefined zones through the navigable network.

5. The method of claim 1, comprising obtaining information indicative of a current travel direction and/or travel speed of the device, and wherein the step of estimating the time interval for which the status of the device is not expected to change comprises using the current travel direction and/or travel speed of the device.

6. The method of claim 5, wherein obtaining information indicative of a current travel direction and/or travel speed of the device comprises storing a plurality of locations of the device that have been obtained at different times, and estimating a current travel direction and/or travel speed of the device from the change in location of the device over time.

7. The method of claim 1, comprising providing the estimated time interval for output to the device.

8. The method of claim 1, further comprising:
when the estimated time interval has elapsed, obtaining an updated current location of the device and determining using the updated current location an updated status for the device.

9. The method of claim 1, comprising providing the determined status for output to the device and/or comprising generating information based on the determined status for output to the device.

10. The method of claim 1, comprising providing the determined status for output to a third party and/or comprising generating information based on the determined status for output to a third party.

11. The method of claim 1, comprising: obtaining a first location of the device within a geographic region at a first time; determining using the first location of the device a first status of the device with respect to the one or more predefined zones within the geographic region, wherein the status indicates which, if any, of the predefined zones the device is located within at the first time; providing the determined first status for output; estimating using the first location of the device and the relative location of the one or more predefined zones a first time interval for which the status of the device is not expected to change; when the first time interval has elapsed, obtaining a second location of the device at a second time; and determining using the second location of the device a second status of the device with respect to the one or more predefined zones within the geographic region, wherein the status indicates which, if any, of the predefined zones the device is located within at the second time.

12. The method of claim 1, wherein at least the steps of obtaining a current location of the device, determining the status of the device and providing the determined status for output are performed by a server, and wherein the device is configured to provide its location to the server for determining its status at a first time and then wait until the estimated time interval has elapsed before providing an updated location to the server.

13. A system configured to obtain information regarding the location of a device with respect to one or more predefined zones within a geographic region within which the device is traveling, the system comprising processing circuitry configured to:
obtain a current location of the device within the geographic region;
determine using the current location of the device a status of the device with respect to the one or more predefined zones within the geographic region, wherein the status indicates which, if any, of the predefined zones the device is currently located within;
provide the determined status for output; and
estimate using the current location of the device and the relative locations of the one or more predefined zones a time interval for which the status of the device is not expected to change.

14. (canceled)

15. A computer program product comprising computer readable instructions adapted to, when executed by a processor, cause the processor to perform a method for obtaining information regarding the location of a device with respect to one or more predefined zones within a geographic region within which the device is traveling, the method comprising:
obtaining a current location of the device within the geographic region;
determining using the current location of the device a status of the device with respect to the one or more predefined zones within the geographic region, wherein the status indicates which, if any, of the predefined zones the device is currently located within:
providing the determined status for output; and
estimating using the current location of the device and the relative locations of the one or more predefined zones a time interval for which the status of the device is not expected to change.

16. The system of claim 13, wherein the system is a server.
